(19) United States
(12) Patent Application Publication
(10) Pub. No.: US 2024/0094596 A1
(43) Pub. Date: Mar. 21, 2024

(54) OPTICAL ELEMENT, OPTICAL DEVICE, AND METHOD FOR PRODUCING OPTICAL ELEMENT

(71) Applicant: INTER-UNIVERSITY RESEARCH INSTITUTE CORPORATION NATIONAL INSTITUTES OF NATURAL SCIENCES, Mitaka-shi, Tokyo (JP)

(72) Inventor: Takunori TAIRA, Okazaki-shi, Aichi (JP)

(73) Assignees: INTER-UNIVERSITY RESEARCH INSTITUTE CORPORATION NATIONAL INSTITUTES OF NATURAL SCIENCES, Mitaka-shi, Tokyo (JP); INTER-UNIVERSITY RESEARCH INSTITUTE CORPORATION NATIONAL INSTITUTES OF NATURAL SCIENCES, Mitaka-shi, Tokyo (JP)

(21) Appl. No.: 18/273,296

(22) PCT Filed: Jan. 20, 2022
(86) PCT No.: PCT/JP2022/002010

§ 371 Date: Jul. 20, 2023

(30) Foreign Application Priority Data
Jan. 21, 2021 (JP) 2021-008025

(51) Int. Cl. G02F 1/35; G02F 1/355; G02F 1/377

(52) U.S. Cl. CPC G02F 1/3509; G02F 1/3548; G02F 1/3551; G02F 1/377

(57) ABSTRACT

An optical element according to an embodiment includes: a substrate having a first main surface and a second main surface on a side opposite to the first main surface and formed of single crystal, ceramic, or glass; and a heat sink bonded to the second main surface and having a refractive index lower than that of the first substrate, wherein a waveguide is formed in the substrate, wherein each of a pair of side surfaces of the waveguide in a direction intersecting with an extending direction of the waveguide and a thickness direction of the substrate is a modified surface obtained by modifying the substrate, and wherein the modified surface extends from the first main surface to the second main surface.

### TECHNICAL FIELD

The present invention relates to an optical element, an optical device, and a method for producing an optical element.

### BACKGROUND ART

Non-Patent Literature 1 to 5 is known as the related art in this technical field. In the literature, a technique in which a waveguide is formed using a fact that an optical material is irradiated with femtosecond ultrashort pulsed laser light, and thus the irradiated region is non-thermally processed and modified, and the refractive index of the irradiated region changes as the volume of the irradiated region increases is disclosed.

### CITATION LIST

### Patent Literature

[Patent Literature 1] Japanese Unexamined Patent Publication No. 2019-129252
[Non-Patent Literature 1] F. Chen and J. R. Vazquez de Aldana, “Optical waveguides in crystalline dielectric materials produced by femtosecond-laser micromachining,” Laser Photon. Rev., 2014, 8(2), 251-275.
[Non-Patent Literature 2] W. F. Silva, C. Jacinto, A. Benayas, J. R. Vazquez de Aldana, G. A. Torchia, F. Chen, Y. Tan, and D. Jaque, “Femtosecond-laser-written, stress-induced Nd:YVO₄ waveguides preserving fluorescence and Raman gain,” OPTICS LETTERS, 2010, Vol. 35, No. 7, 916-918.
[Non-Patent Literature 3] V. Apostolopoulos, L. Laversenne, T. Colomb, C. Depeursinge, R. P. Salathe, M. Pollnau, R. Osellame, G. Cerullo, and P. Laporta, “Femtosecond-irradiation-induced refractive-index changes and channel waveguiding in bulk Ti³⁺:Sapphire,” Appl. Phys. Lett, 2004, 85, 1122-1124.
[Non-Patent Literature 4] Ben McMillen, Kevin P. Chen, Honglin An, Simon Fleming, Vincent Hartwell, and David Snoke, “Waveguiding and nonlinear optical properties of three-dimensional waveguides in LiTaO₃ written by high repetition rate ultrafast laser,” Appl. Phys. Lett, 2008, 93, 111106-1 to 111106-3.
[Non-Patent Literature 5] A. Rodenas, G. A. Torchia, G. Lifante, E. Cantelar, J. Lamela, F. Jaque, L. Roso, and D. Jaque, “Refractive index change mechanisms in femtosecond laser written ceramic Nd:YAG waveguides: micro-spectroscopy experiments and beam propagation calculations,” Appl. Phys. B, 2009, 95, 85-96.

### SUMMARY OF INVENTION

### Technical Problem

For example, in forming a waveguide in Non-Patent Literature 1, stippling cylindrical laser processing is required for forming the waveguide. Therefore, forming the waveguide is complicated, a confinement effect required for the waveguide is low, and waveguide laser oscillation characteristics and nonlinear wavelength conversion characteristics are low. Moreover, since a femtosecond laser light is used for processing, an optical element having a waveguide cannot be easily produced.

Accordingly, an object of the present invention is to provide an optical element which can improve a confinement effect and be easily produced and has a waveguide, an optical device comprising the optical element, and a method for producing the optical element.

### Solution to Problem

According to the present invention, there is provided an optical element including: a substrate having a first main surface and a second main surface on a side opposite to the first main surface and formed of single crystal, ceramic, or glass; and a light confinement member provided on the second main surface, wherein a waveguide is formed in the substrate, wherein each of a pair of side surfaces of the waveguide in a direction intersecting with an extending direction of the waveguide and a thickness direction of the substrate is a modified surface obtained by modifying the substrate, and wherein the modified surface extends from the first main surface to the second main surface.

In the above optical element, the waveguide is formed with the pair of side surfaces which are modified surfaces and the light confinement member. In this case, since light confinement on a side of the second main surface in the waveguide is achieved by the light confinement member, a light confinement effect is improved. Furthermore, since light confinement on a side of the second main surface in the waveguide is achieved by the light confinement member, the optical element can be produced more easily than, for example, in a case where confinement on a side of the second main surface is executed by the modified surface.

The light confinement member may be a heat sink having a refractive index lower than that of the substrate. With this configuration, even if the substrate heats up in a case where high-output laser light is propagated through the waveguide, the heat sink can reduce the temperature rise of the substrate.

The light confinement member may have a reflective coating layer and a heat sink, and the reflective coating layer may be disposed between the second main surface and the heat sink. In this case, light is effectively confined in the waveguide.

The substrate may be formed of a solid-state laser base material. In this case, the optical element can be used as a laser element.

The substrate may be formed of nonlinear optical crystal. In this case, the optical element can be used as a wavelength conversion element, for example.

The substrate may have a quasi-phase matching structure.

An optical device according to the present invention includes the optical element described above.

According to the present invention, there is provided a method for producing an optical element having a waveguide, including: a stacking step of stacking a substrate having a first main surface and a second main surface on a side opposite to the first main surface and formed of single crystal, ceramic, or glass and a light confinement member on each other such that the light confinement member is disposed on the second main surface of the substrate; and a modifying step of modifying the substrate using pulsed laser light to form, in the substrate, a pair of side surfaces of the waveguide in a direction intersecting with an extending direction of the waveguide and a thickness direction of the substrate.

In the method for producing the optical element, the waveguide is formed by the pair of side surfaces formed by modifying the substrate through irradiation with the pulsed laser light and the light confinement member. In this case, since light confinement on a side of the second main surface in the waveguide is achieved by the light confinement member, a light confinement effect is improved. Furthermore, since light confinement on a side of the second main surface in the waveguide is realized by the light confinement member, the optical element can be produced more easily than, for example, in a case where confinement on a side of the second main surface is executed by the modified surface.

A pulse width of the pulsed laser light may be 0.2 ps to 10 ns. A pulse width of the pulsed laser light may be 1 ps to 1 ns. In this case, for example, compared to the case of using femtosecond laser light, a device for outputting the pulsed laser light can be simplified.

The light confinement member may be a heat sink having a refractive index lower than that of the substrate, and in the stacking step, the heat sink may be bonded to the second main surface at room temperature. In this case, even if the substrate heats up in a case where high-output laser light is propagated through the waveguide, the heat sink can reduce the temperature rise of the substrate.

The light confinement member may have a heat sink, and in the stacking step, a reflective coating layer may be formed on the substrate or the heat sink, and then the heat sink and the substrate may be stacked on each other such that the reflective coating layer is sandwiched between the heat sink and the substrate. In this case, light is effectively confined in the waveguide.

The substrate may be formed of a solid-state laser base material. In this case, the optical element can be used as a laser element.

The substrate may be formed of nonlinear optical crystal. In this case, the optical element can be used as a wavelength conversion element, for example.

The substrate may have a quasi-phase matching structure.

### Advantageous Effects of Invention

According to the present invention, it is possible to provide an optical element having a waveguide and an optical device having the optical element which can improve a confinement effect and can be easily produced and a method for producing the optical element.

### BRIEF DESCRIPTION OF DRAWINGS

FIG. 1 is a perspective view showing a schematic configuration of an optical element according to a first embodiment.

FIG. 2 is a view for explaining a method of producing the optical element shown in FIG. 1.

FIG. 3 is a side view showing a schematic configuration of an optical element according to a second embodiment.

FIG. 4 is a perspective view showing a schematic configuration of an optical element according to a third embodiment.

FIG. 5 is a plan view showing a schematic configuration of an optical device according to a fourth embodiment.

FIG. 6 is a perspective view showing a schematic configuration of an optical element according to a fifth embodiment.

FIG. 7 is a side view showing a schematic configuration of an optical element according to a sixth embodiment.

### DESCRIPTION OF EMBODIMENTS

Hereinafter, embodiments of the present invention will be described in detail with reference to the accompanying drawings. In the description of the drawings, the same reference signs are used for the same or equivalent elements, and repetitive descriptions are omitted. The dimensional proportions of the drawings do not necessarily match those of the description.

### First Embodiment

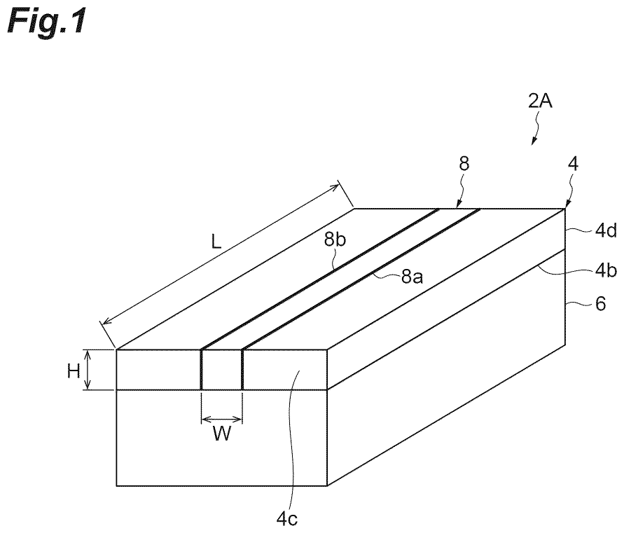

As shown in FIG. 1, an optical element 2A according to an embodiment includes a substrate 4 and a heat sink (a light confinement member) 6, and a waveguide 8 is formed in the substrate 4. In FIG. 1, for convenience of explanation, a pair of side surfaces 8a and 8b of the waveguide 8 are schematically indicated by thick solid lines. A method of illustrating the side surfaces of the waveguide is the same in other figures.

The substrate 4 has a first main surface 4a and a second main surface 4b (a surface opposite to the first main surface 4a in a thickness direction of the substrate 4). An example of a thickness H of the substrate 4 is 5 μm to 1 mm. The shape of the substrate 4 in a plan view (the shape of the substrate 4 viewed in the thickness direction) is not limited, but is, for example, rectangular or square. In a case where the shape of the substrate 4 in a plan view is rectangular, an example of a length L in a long side direction is 1 mm to 100 mm.

The substrate 4 is an optical member that can transmit light propagating through the waveguide 8. The substrate 4 is formed of single crystal, ceramic, or glass. The substrate 4 may be formed of a solid-state laser base material (a laser medium).

Examples of the above single crystal include garnet-based crystal such as YAG, GGG, LuAG, YSAG, YGAG, or YALO; sesquioxide-based crystal such as Y₂O₃, Sr₂O₃, or Lu₂O₃; vanadate-based crystal such as YVO₄, GdVO₄, or LuVO₄; fluoride-based crystal such as CaF₂ or YLF; apatite-based crystal such as FAP or sFAP; and tungstate-based crystal such as KYW or KGW. Examples of the ceramic include polycrystal of a material similar to the single crystal, such as YAG ceramic; an isotropic material such as LuAG, YSAG, YGAG, Y₂O₃, Sr₂O₃, or Lu₂O₃; anisotropic FAP; and the like. Such single crystal and ceramic function as solid-state laser base materials.

In a case where the substrate 4 is formed of a solid-state laser base material, a luminescent center may be added to the substrate 4. The luminescent center includes rare earth elements (Nd, Yb, Tm, Ho, Er, Ce, Pr, and the like), transition metal elements (Cr, Ti, V, and the like), and the like.

The substrate 4 may be formed of nonlinear optical crystal. Examples of the material of the substrate 4 formed of nonlinear optical crystal include quartz (SiO₂), a ferroelectric material, a semiconductor material, a borate-based material, and the like.

Examples of the ferroelectric material include LiNbO₃ (including both cases where Mg is added and Mg is not added), LiTaO₃ (including both cases where Mg is added and Mg is not added), KTiPO₄ (including both cases where Rb is added and Rb is not added), RbTiPO₄ (including both cases where Rb is added and Rb is not added), KTiOAsO₄, RbTiOAsO₄, and the like.

Examples of the semiconductor material include GaAs, GaP, GaN, ZnS, ZnSe, ZnTe, ZnGeP₂, CdSiP₂, and the like.

Examples of the borate-based material include LiB₃O₅, BaB₂O₄, Ca(BO₃)₃F, CsLiB₆O₁₀, Ca₄LnO(BO₃)₃ (Ln=Gd, Y), and the like.

The heat sink 6 is a member having a refractive index lower than that of the substrate 4 and a thermal conductivity higher than that of the substrate 4. Examples of a material for the heat sink 6 include sapphire, diamond, and the like. The heat sink 6 is bonded to the second main surface 4b of the substrate 4. The heat sink 6 may be bonded to the substrate 4 through room temperature bonding.

The waveguide 8 is formed in the substrate 4. In the form shown in FIG. 1, the waveguide 8 extends from a first end surface 4c to a second end surface 4d of the substrate 4. Each of the pair of side surfaces 8a and 8b of the waveguide 8 is disposed in a direction intersecting with an extending direction (an optical axis direction) of the waveguide 8 and the thickness direction of the substrate 4. In the form shown in FIG. 1, the pair of side surfaces 8a and 8b are disposed in a direction orthogonal to an extending direction (an optical axis direction) of the waveguide 8 and the thickness direction of the substrate 4. The pair of side surfaces 8a and 8b face each other. The pair of side surfaces 8a and 8b are modified surfaces obtained by modifying the substrate 4. The pair of side surfaces 8a and 8b can be formed by laser writing. Specifically, the pair of side surfaces 8a and 8b are surfaces formed by condensing laser light onto the substrate 4 to modify the substrate 4 such that a laser condensing region of the substrate 4 has a lower refractive index than the vicinity thereof. The modified surface is also a surface whose refractive index is modulated (a refractive index modulated surface). The length of each of the side surfaces 8a and 8b in the thickness direction of the substrate 4 is the same as the thickness H of the substrate 4, as shown in FIG. 1. An example of a width W of the waveguide 8 (the length in a direction orthogonal to the optical axis direction of the waveguide 8 and the thickness direction of the substrate 4) is 5 μm to 1 mm.

The optical element 2A can be produced as follows.

First, the substrate 4 and the heat sink 6 are stacked on each other by bonding the heat sink 6 to the second main surface 4b of the substrate 4 (a stacking step). The heat sink 6 may be bonded to the substrate 4 through surface activation room temperature bonding, for example. The surface activation room temperature bonding (hereinafter also simply referred to as “room temperature bonding”) is a method in which oxide films or surface deposits on the bonding surfaces of materials to be bonded to each other in a vacuum are removed through ion beam irradiation or FAB (a neutral atom beam) irradiation and the flat bonding surfaces where constituent atoms are exposed are bonded to each other. The room temperature bonding is direct bonding using intermolecular coupling.

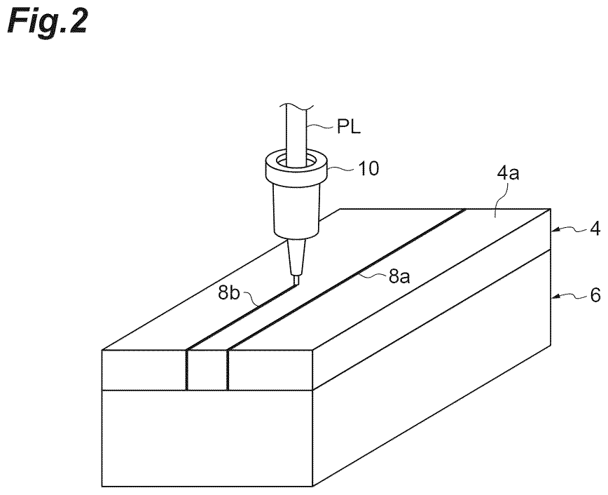

Next, as shown in FIG. 2, the substrate 4 is irradiated with pulsed laser light PL while the pulsed laser light PL is condensed by a condensing part 10, and the substrate 4 at an irradiation position (a condensing position) of the pulsed laser light PL is modified. According to the shape of the waveguide 8 to be formed, three-dimensional scanning is performed using the pulsed laser light PL, and a modified surface to be the pair of side surfaces 8a and 8b of the waveguide 8 is formed (a modifying step).

The pulsed laser light PL may be pulsed laser light with a sub-nanosecond pulse width. The pulse width of the pulsed laser light PL may be 0.2 ps to 10 ns, and preferably 1 ps to 1 ns. An example of a laser device that outputs the pulsed laser light PL is a microchip laser (MCL) that is small, has low power consumption, and can output laser light with a sub-nanosecond pulse width (see Japanese Unexamined Patent Publication No. 2019-129252, for example). An example of the wavelength in a case where the substrate 4 is Nd:YAG and the pulsed laser light PL is a fundamental wave is 1064 nm to 1108 nm, and an example of the wavelength in a case where the substrate 4 is Yb:YAG and the pulsed laser light PL is a fundamental wave is 1024 nm to 1108 nm. As the pulsed laser light PL, not only the fundamental wave, but also harmonic waves such as a second harmonic wave, a third harmonic wave, a fourth harmonic wave, a fifth harmonic wave, a sixth harmonic wave, and a seventh harmonic wave from a solid-state laser may be used. Using the harmonic wave make it possible to increase photon energy without using a large, unstable ultrashort pulsed laser with a pulse width of 0.1 ps or less, thus the harmonic wave interacts with the material efficiently and strongly, and enabling finer processing.

The power, the irradiation time, and the like of the pulsed laser light PL should just be set such that the refractive index at the irradiation position (the condensing position) of the pulsed laser light PL is lower than the refractive index around the irradiation position (around the side surface to be formed). For example, an example of a peak output of the pulsed laser light PL is 0.1 MW to 50 MW. The irradiation time of the pulsed laser light PL to the irradiation position is 1 ps to 1 ns.

The scanning with the pulsed laser light PL may be performed by scanning the laser device itself, or by scanning with the pulsed laser light PL output from the laser device using a mirror or the like.

In the above example of the method for producing the optical element 2A, the waveguide 8 is formed in the substrate 4 after the substrate 4 and the heat sink 6 are stacked on each other. However, the substrate 4 and the heat sink 6 may be stacked on each other after the waveguide 8 is formed in the substrate 4.

In the optical element 2A, the waveguide 8 is formed with the pair of side surfaces 8a and 8b formed by modifying the substrate 4 through irradiation with the pulsed laser light PL and the heat sink 6. Since the heat sink 6 has a lower refractive index than the substrate 4, the heat sink 6 can confine light in the waveguide 8 on a side of the second main surface 4b. That is, the heat sink 6 functions as a light confinement member. In this way, the light confinement in the waveguide 8 on a side of the second main surface 4b is realized by the heat sink 6, and thus a light confinement effect in the waveguide 8 is improved. Since a part of the waveguide 8 is formed with the heat sink 6, it is sufficient that a region to be modified using the pulsed laser light PL is a region corresponding to the pair of side surfaces 8a and 8b. Therefore, for example, the optical element 2A can be produced more easily and in a shorter time than a case where all surfaces for confining the waveguide 8 are formed using the pulsed laser light PL.

In a case where a pulsed laser light having a sub-nanosecond pulse width (for example, a pulse width of 0.2 ps to 10 ns) is used as the pulsed laser light PL, the size of the laser device can be reduced more than in a case where femtosecond pulsed laser light is used, for example. For example, it is possible to use the microchip laser mentioned above. In this case, since it is easy to handle the laser device, it is easy to form the waveguide 8.

In a case where the material of the substrate 4 is single crystal or ceramic (especially in a case where the material of the substrate 4 is a material used for a solid-state laser base material), the substrate has a high resistance to high-output laser light. Furthermore, since the heat sink 6 is used as part of the light confinement, a high light confinement effect can be obtained. As a result, high-output laser light can be propagated through the waveguide 8, and the optical element 2A can be used as an optical component (for example, a laser element) for high-output laser light used for laser processing or the like.

Further, the single crystal or the ceramic has higher thermal conductivity and larger stimulated emission cross-sectional area than the glass. Furthermore, in the optical element 2A, the confinement effect is improved as described above. Therefore, it is possible to realize a laser device that satisfies at least one of compactness, high efficiency, and high output using the above optical element 2A formed of the single crystal or the ceramic.

Since the optical element 2A is provided with the heat sink 6, even if the substrate 4 is heated by the propagation of the high-output laser light as described above, the temperature rise of the substrate 4 can be reduced because the heat sink 6 is bonded to the substrate 4.

In a case where the bonding between the substrate 4 and the heat sink 6 is the room temperature bonding, different materials are bonded to each other at room temperature. Therefore, it is possible to obtain a waveguide 8 that has a high resistance to the power of light propagating through the waveguide 8, can handle high-output light, and has a high confinement effect compared to the case of bonding using an adhesive or the like, for example.

In a case where the substrate 4 is formed of the solid-state laser base material, the optical element 2A can be used as a laser element included in an optical oscillator, an optical amplifier, a laser device, or the like. In a case where the substrate 4 is formed of the solid-state laser base material, the substrate 4 has a high resistance to the high-output laser light, and as described above, the confinement effect is improved in the waveguide 8. As a result, it is possible to realize an optical oscillator, an optical amplifier, and a laser device that satisfy at least one of compactness, high efficiency, and high output.

In a case where the optical element 2A is formed of the nonlinear optical crystal, the optical element 2A can be used as a wavelength conversion element, for example. In the form in which the waveguide 8 is formed of the nonlinear optical crystal, it is possible to realize a nonlinear wavelength conversion element that satisfies at least one of compactness and high output using the optical element 2A.

Next, various modification examples and application examples of the optical element 2A will be described as embodiments.

### Second Embodiment

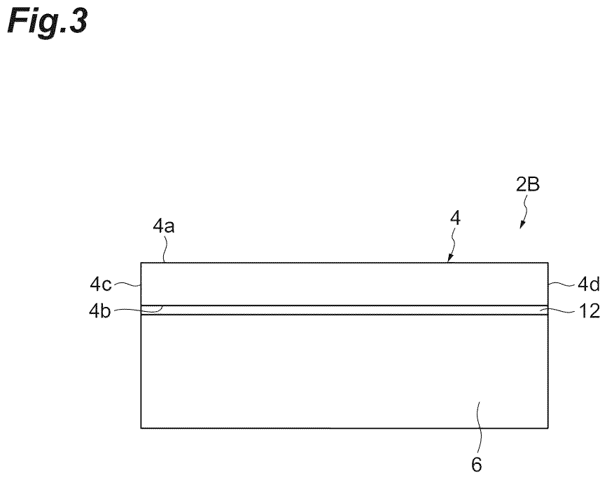

Like an optical element 2B shown in FIG. 3, the optical element 2B may have an intermediate layer 12 between a substrate 4 and a heat sink 6. The intermediate layer 12 may be formed of, for example, Al₂O₃, SiO₂, or the like. The intermediate layer 12 may be a layer formed when the substrate 4 and the heat sink 6 are bonded to each other. In this case, the intermediate layer 12 is integrated with the substrate 4 or the heat sink 6. In a second embodiment, the intermediate layer 12 is a part of the light confinement member.

For example, in a case where the material of the substrate 4 is a solid-state laser base material and the substrate 4 and the heat sink 6 are bonded to each other at room temperature, the substrate 4 and the heat sink 6 are bonded to each other via the intermediate layer 12. In this case, the intermediate layer 12 functions as a buffer layer. The material of the intermediate layer 12 is as illustrated. The intermediate layer 12 may contain constituent elements of the substrate 4 and constituent elements of the heat sink 6. In a case where the substrate 4 and the heat sink 6 are bonded to each other at room temperature, the intermediate layer 12 may contain Fe, Ar, or the like. As an example, the room temperature bonding may be executed as follows.

The substrate 4 and the heat sink 6 are disposed in a chamber, and the inside of the chamber is made into a substantially vacuum environment. The intermediate layer 12 is formed on each of the second main surface 4b of the substrate 4 and the surface of the heat sink 6 on a side of the substrate 4. The intermediate layer 12 on a side of the substrate 4 and the intermediate layer 12 on a side the heat sink 6 have a thickness of, for example, about 10 nm. The intermediate layer 12 may be formed by sputtering, vapor deposition, or the like. The intermediate layer 12 for the room temperature bonding contains an element that can replace the constituent element of at least one of the substrate 4 and the heat sink 6.

In the substantially vacuum environment, the surface of the substrate 4 on a side of the intermediate layer 12 and the surface of the heat sink 6 on a side of the intermediate layer 12 are irradiated with an ion beam or FAB (neutral atomic beam) of argon (Ar) or the like. As a result, oxygen or the like adsorbed on the surface is removed, and a new surface including a dangling bond is formed. The substantially vacuum environment is, for example, a vacuum or reduced-pressure atmosphere with a background pressure of 1×10⁵ Pa or less.

As the ion beam or FAB (neutral atomic beam), rare gases or inert gases such as neon (Ne), krypton (Kr), xenon (Xe), and helium (He) may be used other than argon. Since rare gases are unlikely to cause chemical reactions, they do not significantly change the chemical properties of the surface to be irradiated. Predetermined kinetic energy can be imparted to the ion beam or neutral atomic beam (FAB) by accelerating the particles of the ion beam toward the bonding surface using a particle beam source or plasma generating device.

Next, the intermediate layer 12 side of the substrate 4 and the intermediate layer 12 side of the heat sink 6 are made to face each other. Under room temperature, the new surfaces where bonding arms of the substrate 4 and the heat sink 6 are exposed are brought into contact with each other in the substantially vacuum environment. As a result, a coupling force is generated by interactions between atoms, and the substrate 4 and the heat sink 6 are strongly coupled with each other via the intermediate layer 12. The substantially vacuum environment is, for example, a vacuum or reduced-pressure atmosphere with a background pressure of 1.5×10⁻⁶ Pa or less. A predetermined pressure (1.5 to 2.0 MPa) may be applied to the substrate 4 and heat sink 6 which have been brought into contact with each other.

The optical element 2B is the same as the optical element 2A of the first embodiment except that it has the intermediate layer 12. Therefore, the optical element 2B has the same effect as the optical element 2A.

### Third Embodiment

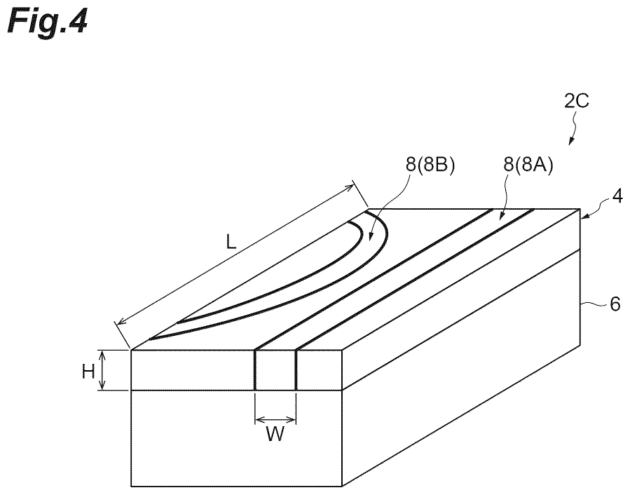

Like an optical element 2C shown in FIG. 4, a plurality of waveguides 8 may be formed in a substrate 4 of the optical element 2C. The number and shapes of the waveguides 8 should just be determined according to the use of the optical element 2C. FIG. 4 shows a case where two waveguides 8 are formed. The two waveguides 8 shown in FIG. 4 are referred to a waveguide 8A and a waveguide 8B. In the form shown in FIG. 4, the waveguides 8A and 8B are close to each other such that light (for example, laser light) propagating through each of the waveguides 8A and 8B are optically coupled with each other in a part thereof.

A method of forming the plurality of waveguides 8 is the same as that in the first embodiment. That is, the waveguide 8 can be formed by modifying the portion of the substrate 4 to be the side surface of each waveguide 8 with the pulsed laser light PL. In this case, since each waveguide 8 can be formed by scanning with the pulsed laser light PL, it is easy to form the plurality of waveguides 8 in the substrate 4. The configuration of the optical element 2C is the same as that of the optical element 2A except that the plurality of waveguides 8 are formed in the substrate 4. Therefore, the optical element 2C has the same effect as the optical element 2A.

As shown in FIG. 4, in the form in which the waveguides 8A and 8B are close to each other such that light propagating through each of the waveguides 8A and 8B are optically coupled with each other in a part thereof, the optical element 2C functions as an optical coupling element that optically couples laser light propagating through each of the waveguides 8A and 8B and having different wavelengths. The optical element 2C shown in FIG. 4 can also function as an optical branching element that branches some of laser light propagating through one waveguide 8 (for example, the waveguide 8A) to the other waveguide 8 (for example, the waveguide 8B).

### Fourth Embodiment

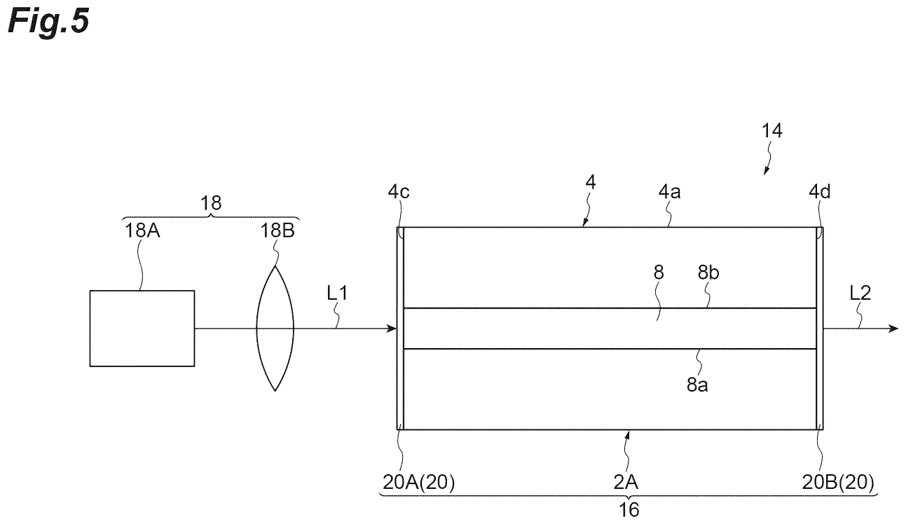

In a case where the material of the substrate 4 is a solid-state laser base material, the optical element can be used for an optical oscillator, an optical amplifier, a laser device, and the like. An example of an oscillator and a laser device using the optical element 2A will be described with reference to FIG. 5. A laser device is also an example of an optical device including an optical element.

As shown in FIG. 5, a laser device (an optical device) 14 includes an optical oscillator 16 having the optical element 2A. The laser device 14 may include an excitation light source unit 18 that supplies excitation light L1 to the optical element 2A. In the fourth embodiment, a case where the laser device 14 includes the excitation light source unit 18 will be described. In the following description, laser light output from the laser device 14 is referred to as laser light L2.

The optical oscillator 16 has the optical element 2A and a resonator 20. The optical element 2A is the optical element 2A described in the first embodiment. In the fourth embodiment, the material of the substrate 4 is single crystal or ceramic functioning as a solid-state laser base material (a laser medium), and a luminescent center is added thereto.

The resonator 20 has a first mirror (a first reflector) 20A disposed on a side of the excitation light source unit 18 and a second mirror (a second reflector) 20B disposed on an output side of the laser light L2. It is sufficient that the first mirror 20A and the second mirror 20B have transmittance and reflectance so as to function as a resonator for laser oscillation in the laser device 14.

The first mirror 20A transmits the excitation light L1 and reflects the laser light L2. The second mirror 20B reflects the laser light L2. For example, the reflectance of the second mirror 20B with respect to the laser light L2 is about 80% to 95% for CW and about 40% to 90% for Q switching. The first mirror 20A is, for example, a dielectric multilayer film formed on the first end surface 4c of the substrate 4. The first mirror 20A is, for example, a dielectric multilayer film that functions as an AR coat for the excitation light L1 and functions as an HR coat for the laser light L2. The second mirror 20B is, for example, a dielectric multilayer film that functions as a PR coat (a partial reflection coat) for the laser light L2.

The first mirror 20A and the second mirror 20B may be disposed apart from the first end surface 4c and the second end surface 4d. Since the first mirror 20A and the second mirror 20B are dielectric multilayer films formed on the first end surface 4c and the second end surface 4d, a compact laser device 14 can be obtained.

The excitation light source unit 18 has a light source unit 18A that outputs the excitation light L1 and a condensing optical system 18B that condenses the excitation light L1 such that the excitation light L1 enters the waveguide 8. FIG. 5 schematically shows the condensing optical system 18B as a lens. An example of the light source unit 18A is a semiconductor laser element.

The laser device 14 configured as described above can generate the laser light L2 by outputting the excitation light L1 from the excitation light source unit 18.

Further, the single crystal or the ceramic functioning as the solid-state laser base material has higher thermal conductivity and larger stimulated emission cross-sectional area than the glass. Furthermore, in the optical element 2A, the confinement effect is improved as described above. Therefore, using the above optical element 2A formed of the single crystal or the ceramic makes it possible to realize a laser device that satisfies at least one of compactness, high efficiency, and high output.

The laser device 14 may further include a saturable absorber such as a Q-switched element. An example of the material of the saturable absorber is YAG to which Cr is added. The saturable absorber is disposed, for example, between the second end surface 4d and the second mirror 20B. The saturable absorber may be bonded to the substrate 4 (for example, at room temperature). Since the laser device 14 includes the saturable absorber, the laser device 14 can output pulsed laser light. In this case, the laser device 14 can be used as a laser processing device.

For example, in a case where an optical element 2C having two waveguides 8 that are partially close to each other as shown in FIG. 4 is used as the optical element 2A instead of the optical element 2A, the solid-state laser base material in the waveguide 8 may be excited with the excitation light that enters the waveguide 8 and leaks out to a side of the waveguide 8.

### Fifth Embodiment

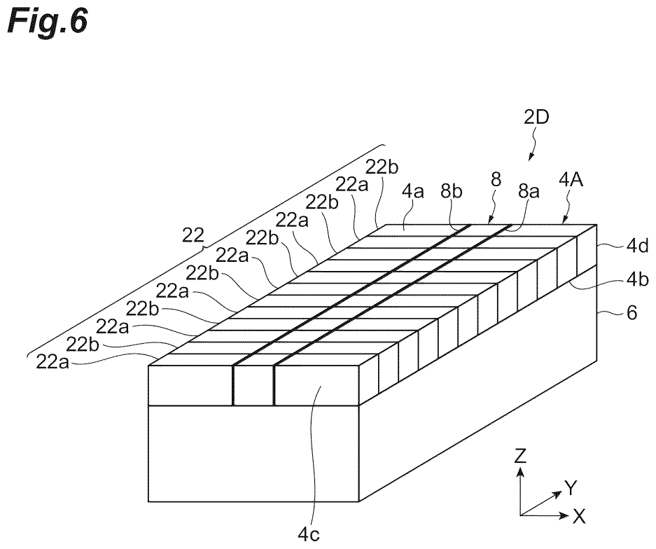

An optical element 2D according to a fifth embodiment will be described with reference to FIG. 6. The optical element 2D has a substrate 4A and a heat sink 6, and a waveguide 8 is formed in the substrate 4A. Hereinafter, for convenience of explanation, in the fifth embodiment, an X direction, a Y direction, and a Z direction may be used as shown in FIG. 6. The Z direction is a thickness direction of the substrate 4A. The X direction and the Y direction are directions orthogonal to the Z direction. In FIG. 6, the Y direction is an extending direction of the waveguide 8, and the X direction is a direction orthogonal to the Y direction. In a case where the planar view shape of the substrate 4A (the shape viewed in the thickness direction) is a rectangle, the Y direction is a longitudinal direction of the substrate 4A, and the X direction is a lateral direction.

The material of the substrate 4A is nonlinear optical crystal, and the substrate 4A has a quasi-phase matching (QPM) structure 22. Examples of a material of the substrate 4A include quartz and a ferroelectric material (for example, lithium niobate (LiNbO₃)).

The quasi-phase matching structure 22 has a plurality of polarity inversion regions 22a and a plurality of polarity non-inversion regions 22b. In FIG. 6, for convenience of explanation, a solid line indicates an interface between the polarity inversion region 22a and the polarity non-inversion region 22b. The plurality of polarity inversion regions 22a and the plurality of polarity non-inversion regions 22b are disposed in one direction (in FIG. 6, the extending direction of the waveguide 8 or the longitudinal direction of the substrate 4A) such that the polarity inversion regions 22a and the polarity non-inversion regions 22b are disposed alternately. The polarity axis of the polarity inversion region 22a and the polarity axis of the polarity non-inversion region 22b are inverted by, for example, 180° from each other. The polarity inversion regions 22a are provided from one side surface to the other side surface in the X direction and are provided from a first main surface 4a to a second main surface 4b in the Z direction. The polarity inversion regions 22a and the polarity non-inversion regions 22b are alternately arranged in the Y direction. The dimension of each polarity inversion region 22a in the X direction corresponds to the dimension of the substrate 4A in the X direction, and the depth of each polarity inversion region 22a in the Z direction corresponds to the thickness of the substrate 4A. Therefore, light propagating through the waveguide 8 is transmitted through all of the plurality of polarity inversion regions 22a.

The plurality of polarity inversion region 22a are separated from each other via the polarity non-inversion regions 22b. That is, the polarity non-inversion region 22b is located between the adjacent polarity inversion regions 22a. The plurality of polarity inversion regions 22a are arranged at predetermined positions derived from the refractive index dispersion of the quartz in the substrate 4A. In the fifth embodiment, the plurality of polarity inversion regions 22a are arranged periodically in the Y direction. The positions (or periods) of the plurality of polarity inversion regions 22a may be determined according to the wavelength and refractive index of light.

In a case where the material of the substrate 4 is quartz, each polarity inversion region 22a can be formed by heating the substrate 4 and applying a stress to the substrate 4. In this case, the polarity non-inversion region 22b is a region to which no stress is applied. In a case where the material of the substrate 4A is a ferroelectric material, each polarity inversion region 22a can be formed, for example, by applying an electric field. In this case, the polarity non-inversion region 22b is a region to which no electric field is applied. For example, in a case where the room temperature bonding is adopted as a method of bonding the substrate 4 and the heat sink 6 to each other, it is possible to bond the substrate 4 which is the quartz having the QPM structure and the heat sink 6 to each other in advance.

The waveguide 8 is formed in the substrate 4A. A method of forming the waveguide 8 is the same as that in the optical element 2A.

The optical element 2D is the same as the optical element 2A except that it has the substrate 4A instead of the substrate 4. Therefore, the optical element 2D has the same effect as the optical element 2A.

The waveguide 8 formed in the substrate 4A having the quasi-phase matching structure 22 functions as a quasi-phase matching waveguide, and the optical element 2D functions as a QPM element. Therefore, the optical element 2D is used for optical harmonic wave generation, sum frequency generation, difference frequency generation, parametric light amplification, parametric light oscillation, ultra-high speed light-optical switching, and the like. In particular, the confinement effect of the waveguide 8 improves the wavelength conversion efficiency. The optical element 2D can be used as a nonlinear optical element necessary to high-performance optical parametric processes required for compact high-output nonlinear wavelength conversion, especially quantum optics (quantum communication, quantum arithmetic, and the like). For example, the optical element 2D can be used in place of the QPM element used in a coherent ising machine, a quantum computer, a quantum sensor, a wavelength conversion device, a laser processing device, and the like. Accordingly, examples of an optical device having the optical element 2D include a coherent ising machine, a quantum computer, a quantum sensor, a wavelength conversion device, a laser processing device, and the like.

In a case where the material of the substrate 4A is the quartz, the optical element 2D as the QPM element has high light resistance and can transmit light with a short wavelength, and thus the optical element 2D is used in various high-output short-wavelength generators, a laser processing device, a quantum arithmetic device requiring high durability, and a device requiring a multiphoton process.

### Sixth Embodiment

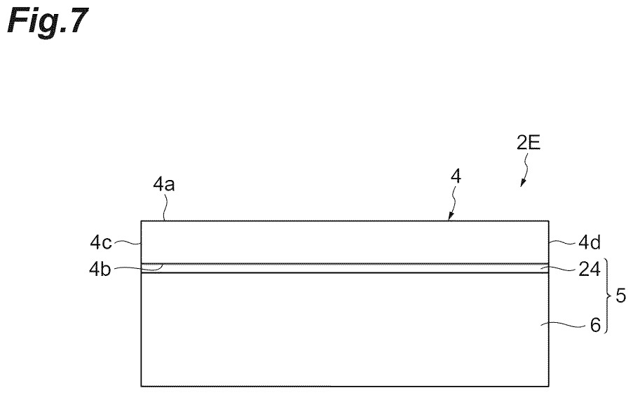

Like an optical element 2E shown in FIG. 7, the optical element 2E may have a structure in which a light confinement member 5 having a reflective coating layer 24 and a heat sink 6 and a substrate 4 are stacked. For the reflective coating layer 24, for example, a dielectric multilayer film is optimal, but a material having a lower refractive index than the substrate 4 and a thickness of from about the wavelength to about 1/10 thereof is sufficient. It is sufficient that the reflective coating layer 24 is a layer that can reflect light to be propagated through a waveguide 8. The optical element 2E can be produced by, for example, forming the reflective coating layer 24 on the heat sink 6 or the substrate 4, and then stacking the substrate 4 and the heat sink 6 on each other such that the reflective coating layer 24 is sandwiched between the heat sink 6 and the substrate 4.

The optical element 2E reflects light propagating through the waveguide 8 by the reflective coating layer 24. Therefore, the leakage of light from the heat sink 6 side can be further curbed, and thus the light can be efficiently propagated through the waveguide 8. In this way, the reflective coating layer 24 contributes to light confinement on a side of the heat sink 6. Therefore, the waveguide 8 can be formed even in a case where a difference in refractive index between the heat sink 6 and the substrate 4 is small. Since the reflective coating layer 24 contributes to light confinement on the heat sink 6 side, the refractive index of the heat sink 6 of the optical element 2E can be made higher than that of the substrate 4. Therefore, the degree of freedom in selecting materials for the substrate 4 and the heat sink 6 is improved. In a case where the substrate 4 is made of a nonlinear material, a difference in refractive index between the substrate 4 and the heat sink 6 tends to be small. Therefore, in a case where the substrate 4 is made of quartz, KTiPO₄, KTiOAsO₄, RbTiOAsO₄, LiB₃O₅, BaB₂O₄, Ca(BO₃)₃F, CsLiB₆O₁₀, or the like, the configuration of the optical element 2E is more effective.

The present invention is intended not to be limited to the various illustrated embodiments, but to include the scope indicated by the claims, and to include all changes within the meaning and scope equivalent to the claims.

The optical element according to the present disclosure can be used in place of a waveguide (including an optical fiber) of the related art. Therefore, examples of the optical device including the optical element according to the present disclosure include a laser measurement device, a laser inspection device, a laser diagnostic device, a laser medical device, an optical communication device, an optical information processing device, a device that uses laser light and is applied to the field of biotechnology, and the like in addition to the examples shown in the above-described various embodiments.

Although the case where the light confinement member has a heat sink is illustrated, the light confinement member may not have a heat sink as long as it is a member capable of confining light in the waveguide. Therefore, for example, the reflective coating layer itself described in the sixth embodiment may be the light confinement member.

The various embodiments and modification examples described above may be appropriately combined without departing from the spirit of the invention.

### REFERENCE SIGNS LIST

2A, 2B, 2C, 2D Optical element
4, 4A Substrate
4a First main surface
4b Second main surface
5 Light confinement member
6 Heat sink (light confinement member)
8 Waveguide
8a, 8b Side surface (a pair of side surfaces)
14 Laser device (optical device)
22 Quasi-phase matching structure
24 Reflective coating layer (light confinement member)
PL Pulsed laser light

1: An optical element comprising:
a substrate having a first main surface and a second main surface on a side opposite to the first main surface and formed of single crystal, ceramic, or glass; and
a light confinement member provided on the second main surface,
wherein a waveguide is formed in the substrate,
wherein each of a pair of side surfaces of the waveguide in a direction intersecting with an extending direction of the waveguide and a thickness direction of the substrate is a modified surface obtained by modifying the substrate, and
wherein the modified surface extends from the first main surface to the second main surface.

2: The optical element according to claim 1, wherein the light confinement member is a heat sink having a refractive index lower than that of the substrate.

3: The optical element according to claim 1,
wherein the light confinement member has a reflective coating layer and a heat sink, and
wherein the reflective coating layer is disposed between the second main surface and the heat sink.

4: The optical element according to claim 1, wherein the substrate is formed of a solid-state laser base material.

5: The optical element according to claim 1, wherein the substrate is formed of nonlinear optical crystal.

6: The optical element according to claim 5, wherein the substrate has a quasi-phase matching structure.

7: An optical device comprising the optical element according to claim 1.

8: A method for producing an optical element having a waveguide, comprising:
a stacking step of stacking a substrate having a first main surface and a second main surface on a side opposite to the first main surface and formed of single crystal, ceramic, or glass and a light confinement member on each other such that the light confinement member is disposed on the second main surface of the substrate; and
a modifying step of modifying the substrate using pulsed laser light to form, in the substrate, a pair of side surfaces of the waveguide in a direction intersecting with an extending direction of the waveguide and a thickness direction of the substrate.

9: The method for producing an optical element according to claim 8, wherein a pulse width of the pulsed laser light is 0.2 ps to 10 ns.

10: The method for producing an optical element according to claim 8, wherein a pulse width of the pulsed laser light is 1 ps to 1 ns.

11: The method for producing an optical element according to claim 8,
wherein the light confinement member is a heat sink having a refractive index lower than that of the substrate, and
wherein, in the stacking step, the heat sink is bonded to the second main surface at room temperature.

12: The method for producing an optical element according claim 8,
wherein the light confinement member has a heat sink, and
wherein, in the stacking step, a reflective coating layer is formed on the substrate or the heat sink, and then the heat sink and the substrate are stacked on each other such that the reflective coating layer is sandwiched between the heat sink and the substrate.

13: The method for producing an optical element according to claim 8, wherein the substrate is formed of a solid-state laser base material.

14: The method for producing an optical element according to claim 8, wherein the substrate is formed of nonlinear optical crystal.

15: The method for producing an optical element according to claim 14, wherein the substrate has a quasi-phase matching structure.
